(19) United States
(12) Patent Application Publication
(10) Pub. No.: US 2026/0092590 A1
(43) Pub. Date: Apr. 2, 2026

(54) SYSTEM FOR GENERATING ELECTRICITY VIA HELICOID VERTICAL AXIS WIND TURBINE AND METHOD THEREOF

(71) Applicant: Aleksei GORLOV, Dubai (AE)

(72) Inventor: Aleksei GORLOV, Dubai (AE)

(21) Appl. No.: 19/115,057

(22) PCT Filed: Sep. 26, 2023
(86) PCT No.: PCT/IB2023/059523

§ 371 Date: Mar. 25, 2025

(30) Foreign Application Priority Data
Sep. 26, 2022 (AE) P6001974/2022

(51) Int. Cl. F03D 3/06; F03D 7/06; F03D 9/11

(52) U.S. Cl. CPC F03D 3/061; F03D 7/06; F03D 9/11; F05B 2250/25

(57) ABSTRACT

The present invention provide a system and method for generating electricity using a helicoid vertical axis wind turbine. The system comprises a rotor designed for rotation from airflow; a plurality of helicoid blades having an airplane wing profile to generate a lifting force from said airflow, enabling rotation of the rotor; a generator mechanically connected to the rotor to produce electricity upon the rotor's rotation; a controller connected to said generator to process the generated electricity; a battery connected to the controller for storing the processed electricity; and an inverter connected to the battery for converting and supplying the stored electricity. The invention provides more versatile, efficient, and reliable system and method for generating electricity via a helicoid vertical axis wind turbine.

### FIELD OF THE INVENTION

Embodiments of the present invention generally relates to the renewable energy generation technologies, more particularly, the present invention relates to a system for generating electricity on highways via a helicoid vertical axis wind turbine and method thereof.

### BACKGROUND OF THE INVENTION

The subject matter discussed in the background section should not be assumed to be prior art merely as a result of it being mentioned in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The evolution of renewable energy technologies, especially in the wind power domain, has been rapid and transformative. Wind energy has emerged as one of the world's fastest-growing sources of electricity, and its application has spanned various geographical terrains and setups, from massive offshore wind farms to smaller onshore installations. A particular sub-category of wind energy devices is vertical axis wind turbines, characterized by their blades rotating around a vertical axis.

Conventionally, the most predominant type of wind turbine is the Horizontal Axis Wind Turbines. These turbines, with blades rotating around a horizontal axis, offer the advantage of efficiency. However, their design necessitates mechanisms to ensure they face the wind, thereby introducing potential complexities and failures in operation. On the other hand, traditional vertical axis wind turbines encompass designs like the Savonius and the Darrieus models. Specifically, the Darrieus type, with its characteristic “egg-beater” design, harnesses lift forces for its rotation.

A further refinement in the vertical axis wind turbine category is the helicoid vertical axis wind turbines. These turbines distinguish themselves with helicoidal or twisted blades. Examples of helicoid vertical axis wind turbines are the models SX-5, SX-7.5, SX-10, SX-15, and SX-20 produced by Wuxi Smaraad New Energy Technology CO. LTD. Despite their innovative design, these models primarily rely on a steady flow of natural wind, making their performance contingent on consistent airflow.

In parallel to the advancements in wind turbines, efforts have been made to leverage the kinetic energy of moving vehicles, particularly through integrative roadside energy systems. These systems, however, predominantly employ piezoelectric materials embedded within roads or harness other direct kinetic energy capture methods, without tapping into the potential of the vehicles' resultant airflow.

The horizontal axis wind turbines, despite their efficiency, are constrained by their need for directional alignment, leading to potential wear and mechanical failures. Traditional vertical axis wind turbines, especially the Savonius type, while being direction-agnostic, often fall short in efficiency and are prone to substantial mechanical wear. The existing helicoid vertical axis wind turbines, for all their innovation, remain heavily dependent on a constant wind flow, and this reliance results in a suboptimal energy capture due to the rotor's low rotational speeds. Lastly, current roadside energy systems exhibit a narrow focus, mainly confining themselves to direct kinetic energy without harnessing the ancillary benefits of vehicular airflow.

Given these gaps in the existing technologies, there is a pressing need for a more versatile, efficient, and reliable system and method for generating electricity via a helicoid vertical axis wind turbine to address the above deficiencies of existing technologies.

### SUMMARY OF THE INVENTION

According to a first aspect of the present invention, there is provided a system for generating electricity using a helicoid vertical axis wind turbine comprises a rotor designed for rotation from airflow; a plurality of helicoid blades having an airplane wing profile to generate a lifting force from said airflow, enabling rotation of the rotor; a generator mechanically connected to the rotor to produce electricity upon the rotor's rotation; a controller connected to said generator to process the generated electricity; a battery connected to the controller for storing the processed electricity; and an inverter connected to the battery for converting and supplying the stored electricity.

In accordance with an embodiment of the present invention, the blade is fabricated from a composite material or plastic produced by vacuum pressing.

In accordance with an embodiment of the present invention, the airflow is derived from natural wind or passing vehicles or a combination thereof.

According to another aspect of the present invention, there is provided a method for generating electricity using a helicoid vertical axis wind turbine. The method comprises capture airflow from passing vehicles or natural wind or a combination thereof; convert said airflow into a rotational force using the rotor configured a helicoid blade, transfer the rotational force to the generator to produce electricity, process the generated electricity through the controller, store the processed electricity in the battery and supplying the stored electricity through the inverter.

### BRIEF DESCRIPTION OF THE DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments. These and other features, benefits and advantages of the present invention will become apparent by reference to the following text figure, with like reference numbers referring to like structures across the views, wherein:

FIG. 1 illustrates an exemplary a system for generating electricity via a helicoid vertical axis wind turbine, in accordance with an embodiment of the present invention; and

FIG. 2 illustrates a flowchart depicting the process steps for generating electricity using a helicoid vertical axis wind turbine, in accordance with an embodiment of the present invention.

### DETAILED DESCRIPTION OF THE DRAWINGS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e., meaning having the potential to), rather than the mandatory sense, (i.e., meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

The present invention will now be described in detail with the help of accompanying drawings:

The present invention provides a helicoid vertical axis wind turbine system designed to efficiently generate electricity. The system captures airflow from both natural sources and the turbulence created by passing vehicles. Central to its design is a rotor with helicoid blades, optimized to harness wind from any direction, negating the need for reorientation mechanisms typical of traditional turbines. Upon capturing the wind, the rotor's rotational force drives a generator to produce electricity. A sophisticated controller then processes this electricity, ensuring a stable and consistent output. The system also includes a battery for energy storage, ensuring continuous power availability even during periods of low wind activity. Finally, an inverter ensures the stored energy can be supplied in a usable form. The present invention versatility, efficiency, and innovative design offer a pioneering approach to renewable energy generation, particularly suitable for urban environments where both natural wind and vehicular turbulence are present.

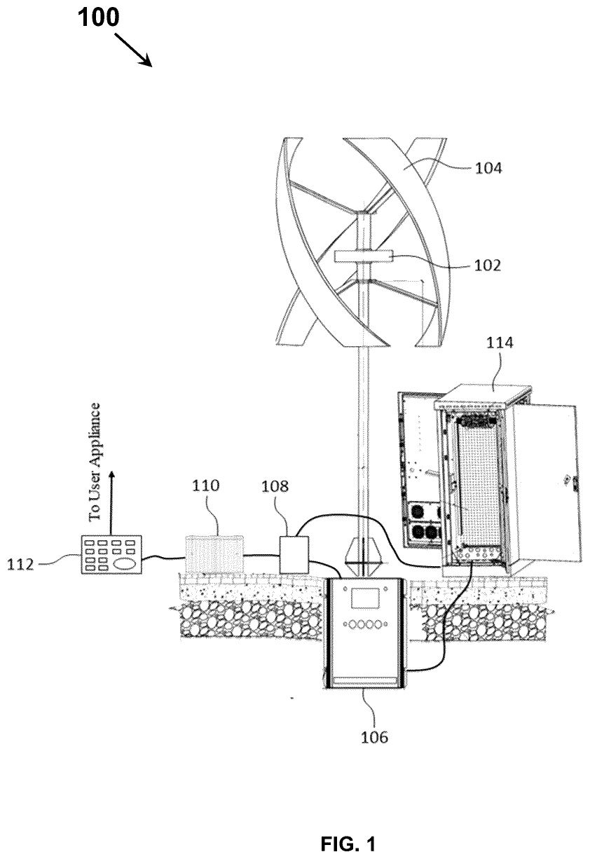

FIG. 1 illustrates a system (100) for generating electricity via a helicoid vertical axis wind turbine. The system (100) includes a rotor (102), a plurality of helicoid blades (104), a generator (106), a controller (108), a battery (110) and an inverter (112).

In an embodiment of the present invention, the electricity generation system (100) is ingeniously designed to capture optimal energy from wind currents, and the helicoid vertical axis blades allows to capture energy from any wind direction. At the heart of present system is the rotor (102), which is positioned vertically and serves as the primary moving component. This rotor (102) captures wind energy and transfers it into mechanical rotation, which in turn powers the adjoining generator. The rotor (102) is a central pillar-like structure that serves as the pivotal backbone of the helicoid vertical axis wind turbine. The rotor (102) may be fabricated from high-strength materials, such as steel or composite materials, which allow it to withstand the mechanical stresses from rotating as well as the environmental stresses from various climatic conditions. Vertically oriented, the rotor (102) often spans from the base of the turbine to the top, giving it the height advantage to leverage wind currents from various levels. Peripherally, the rotor (102) is adorned with mounting points or brackets designed to securely hold the helicoid blades. The configuration ensures that these blades are evenly spaced around the rotor, providing balance and stability during operation. The lower end of the rotor may be anchored to a sturdy base in the ground, and equipped with a bearing mechanism to ensure that the rotor (102) has a smooth, low-friction rotation, which is vital for the efficiency of energy conversion. The upper portion of rotor (102) may also be equipped with a similar bearing or stabilizing system to prevent wobbling during high-speed rotations.

Wrapped around the rotor (102) vertical axis are the plurality of helicoid blades (104) which have an airplane wing profile. The distinct helicoid curved design of blades allow for an efficient capture of kinetic energy from wind currents of any direction and accelerate the rotor (102) into a rotational motion. This configuration advantageously harnesses energy from both ambient winds and more turbulent vortices, such as those produced by passing vehicles. The material selected for the helicoid blade (104) is crucial. Often, composite materials, plastics, or metals are chosen for their lightweight yet strong characteristics. Given the unique shape and the stresses the blade will encounter, the material often undergoes treatments like vacuum pressing to ensure its durability and longevity. At the base and the top, the blade (104) may be consisting mounting connectors which are connected with mounting points or brackets of rotor to ensure secure attachment to the rotor. The length, pitch, and twist of the helicoid blade may vary based on design considerations, but they are optimized to harness wind energy efficiently, especially from turbulent and multidirectional wind sources, like those generated by fast-moving vehicles on highways.

Further the rotor (102) is mechanically connected to the generator (106). The generator (106) may be mounted vertically to ensure the rotor's shaft from the wind turbine is aligned properly with the generator (106). Proper alignment and coupling are critical to avoid mechanical losses and ensure efficient energy transfer. As the rotor spins, it sets the generator (106) into motion and transforming the rotor's mechanical energy into usable electrical energy. The generator (106) is selected from a permanent magnet synchronous generator or an asynchronous generator, depending on the design consideration. The permanent magnet synchronous generator are popular in many wind turbine applications due to their efficiency and capability to generate power at low rotational speeds.

To manage the flow and distribution of the generated electricity, a controller (108) is strategically positioned near the generator. The controller (108) includes an electronic circuitry housed typically within a protective enclosure, regulates the voltage output ensuring it remains within optimal levels, either for immediate consumption or storage. Furthermore, it offers an added layer of protection, guarding the system against potential electrical pitfalls like overcharging.

For times when wind conditions are suboptimal or absent, the system includes a battery (110) to store excess electricity. Positioned close to the generator and controller, the battery, often sheltered within a weather-resistant casing, guarantees a consistent and uninterrupted power supply. Depending on the power demands of the system, there might be an array of batteries, connected either in series or parallel configurations. To ensure the stored energy is compatible with most electrical devices, an inverter (112) is incorporated. Located either adjacent to the battery or closer to the point of end-use, the inverter adeptly converts the battery's direct current into a more universally accepted alternating current.

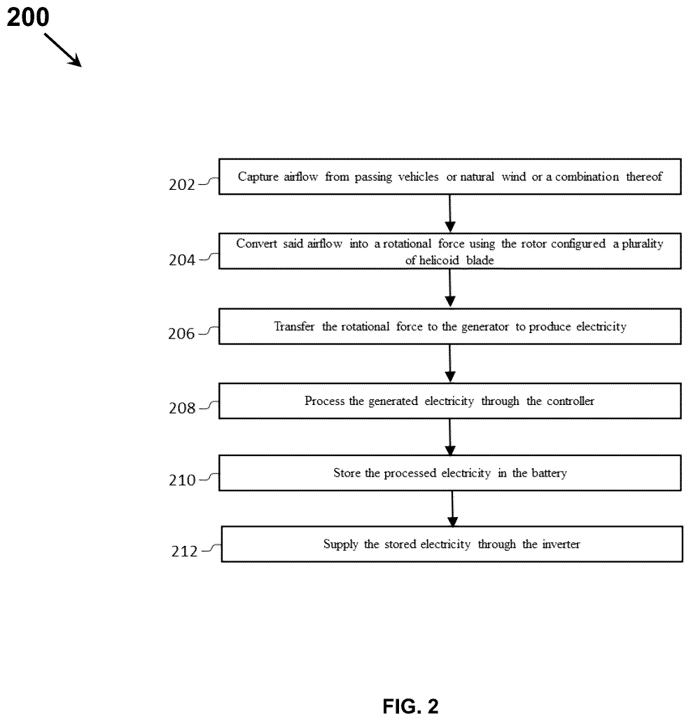

FIG. 2 illustrates a method (200) for generating electricity using a helicoid vertical axis wind turbine. The method includes the following steps:

At step 202, the turbines are strategically positioned along high-speed roads to maximize the interception of airflow created not just by the natural wind but also by the draft generated from passing vehicles.

At step 204, when vehicles pass by, or when there's a gust of natural wind, the plurality of helicoid blades (104) catch the wind of any direction, causing the rotor (102) to initiate a rotational motion. As the wind impacts these blades, it doesn't just push them; it follows the helical contours, ensuring a smoother, longer interaction, which translates into an enhanced rotational force.

At step 206, once the rotor initiates its motion, it doesn't operate in isolation. It's intricately connected to a generator (106). This generator (106) isn't just any machinery but is optimized for this specific application. It possesses internal coils and magnetic fields designed to convert rotational mechanical energy into electrical energy. The rotor's rotation causes the generator's coils to move within its magnetic fields, inducing a flow of electrons, which we perceive as electricity.

At step 208, while capturing and converting wind energy into electricity is a feat in itself, the raw output can be unpredictable. Variability in wind speed and direction might cause surges or lulls in the generated electricity. The controller (108), equipped with advanced electronic circuitry, controller, plays the role of a vigilant regulator. It continuously monitors the incoming electrical flow, adjusting voltage and current to ensure a consistent output. It filters out high-energy spikes, which could potentially damage appliances or the battery system. Its advanced algorithms ensure that the energy sent for storage or immediate consumption is of the highest quality.

At step 210, Consistency in energy supply is a necessity, especially if the system (100) intends to cater to households, street lights, or other infrastructures. The integrated battery system addresses this. Comprising advanced cells, possibly the latest in Lithium Iron Phosphate technology, the battery (110) can store large quantities of energy. This storage capability ensures that during periods of low wind activity or when vehicular traffic is sparse, the stored energy can bridge the demand-supply gap.

At step 212, the stored electricity, in Direct Current (DC) format, may not be directly usable for all applications. The inverter (112) steps in as a sophisticated device that transforms DC into Alternating Current (AC). The AC power, with its sinusoidal waveform, is compatible with household appliances, the grid, and more application.

The method describes a systematic process wherein wind energy, either from natural sources or artificially created by passing vehicles, is harnessed using a uniquely designed rotor. The harnessed energy is then converted, processed, stored, and finally supplied in a usable form, ensuring maximum efficiency and utilization of the available wind resource.

The present invention will be better understood with a help of a working example. It will be appreciated by a person skilled in the art that the values of various parameters mentioned below or materials or exact types of components used, should be considered as exemplary and not in a strict/limiting sense. Any discussion of documents, acts, materials, devices, articles and the like, included in the example is solely for the purpose of providing a context for the present invention.

In an exemplary embodiment of the present invention, the present electrical generation system, having a 5 KW capacity, incorporates components with the following specifications:

1) The rotor's design varies depending on the installation site of the system.

2) Multiple factors determine the number of blades affixed to the rotor, such as, available installation space, frequency of passing vehicles, and the average natural wind speed.

3) The system employs a 5 KW wind generator. This generator operates at a rated wind turbine voltage of 380 VAC and a battery voltage of 384 V. Its functional temperature spectrum ranges from −25 C to +60 C, utilizing natural convection cooled by dual fans. Notably, the generator operates quietly with noise levels below 40 dBA.

4) The helicoid vertical axis wind turbine system can utilize a variety of controllers, each designed to optimize power generation and management. Controllers could include but are not restricted to: Maximum Power Point Tracking Controller, Pulse Width Modulation Controller, Torque Controller, Pitch Controller, Voltage and Frequency Controller, Battery Management Controller, and Communication Controller. The selection of an appropriate controller, or a blend of controllers, hinges on the specific objectives of the wind turbine system, be it maximizing power output, prolonging battery longevity, ensuring operational safety, or synchronization with auxiliary systems.

5) The LiFePO4 (Lithium Iron Phosphate) battery emerges as an optimal choice for this wind energy system, due to its ability to draw power from both vehicular-induced and natural wind sources. Known for long-lasting life cycles, safety features, and consistent performance, these batteries excel in renewable energy applications. A single battery cell offers a nominal voltage of 3.2 V, with a general capacity averaging around 230 Ah, suggesting a substantial energy reserve. The peak storage capacity might slightly exceed this, approaching 240 Ah. Crucially, the battery's internal resistance remains minimal, fluctuating between 0.1 and 0.3 mΩ.

Physically, the battery showcases an aluminum shell, combining effective heat dispersion with lightweight properties. Its dimensions measure 174×552×208 mm, weighing in at roughly 4.1±0.1 kg. For operational optimization, the battery's discharge voltage oscillates between 2.5 V and 3.65V. Recommended charge and discharge DC currents stand at 233 A˜241 A (1C) and 120 A (0.5 C) respectively. Nevertheless, in high-demand scenarios, the battery can output a continuous discharge current reaching up to 240 A (1 C).

A standout feature of this battery is its durability. Operating at an 80% Depth of Discharge (DOD) at 25° C. with 0.5 C/0.5 C, it can endure beyond 3500 cycles. At a 70% DOD under identical conditions, this extends to over 4000 cycles, making it especially suitable for wind energy's inconsistent nature. The battery's operational temperature bandwidth is extensive, allowing for charging between 0-55° C., discharging from −20 to 55° C., and an overall operational window from −20 to 60° C. Connections are streamlined via its Screw Type M6 terminals.

6) The designated inverter for this 5 KW system is the SW480-80KS model. With an input rating voltage (Vpc) of 480 volts and an input current of 208 A, it exemplifies robust power handling capabilities. This inverter can easily manage an input DC voltage spanning from 400-650 Vpc. Output-wise, it can deliver up to 80 KW, reflecting its substantial conversion capacity, while maintaining an output rating voltage and frequency at AC380V/220 Vac, 50 Hz, via a three-phase four-wire setup.

Precision underscores this inverter's design. Its output voltage accuracy hovers around AC380V±3%, and frequency precision sits at a tight 50 Hz+0.05. The AC output quality is noteworthy; wave distortion (THD) remains under 3% for linear loads. Furthermore, its dynamic response to shifting loads, from 0% to 100%, remains steadfast at 5%. Under an 80% resistance load, the inverter operates at a power factor (PF) of 0.8. It showcases resilience with an overload capacity of 150% for 10 seconds and a crest factor (CF) of 3:1. The device's efficiency rating is an impressive 92%.

Prioritizing safety, the inverter can sustain strengths between input and output up to 1500 Vac for a minute. Environmentally, it operates quietly, registering below 50.5 dB at a meter's distance. It functions reliably across a temperature spectrum of −25° C. to +55° C., tolerating humidities up to 95% without condensation, and performing at elevations as high as 6000 meters. The inverter's structure dimensions are 650 mm in width, 1420 mm depth, and 1365 mm in height, weighing approximately 780 KG. Importantly, it's fortified with safety features including input reversing, low-voltage protection, output overload, short-circuit protection, and overheat shielding.

In accordance with another embodiment of the present invention, a microclimate system power supply (114) is provided with both above described primary and auxiliary components. Power sourcing and additional installations are conducted through the VRU's (Voltage Regulation Unit) input switchgear. The VRU encompasses two distinct cabinet configurations 1. The STV-1 VRU cabinet, where the telecommunications compartment is housed within a modular 19″ setup, and 2. The STV-2 VRU cabinet, which features an electrical compartment fixed on a galvanized perforated panel.

The principal connection for the power supply from an external grid is facilitated via a terminal block, an integral component of the VRU. Additionally, the SHTV-2 cabinets offer a provision for a secondary power connection. This backup power is derived from the DCU, and connection is achieved through a single-phase input plug. Transitioning from the primary to this backup power source is orchestrated by a modular switch, which is subsequently affixed to the VRU.

Ventilation is prioritized with a system embedded within the door. This system is composed of either one or two fan modules, strategically situated above filters boasting enhanced filtration regions. For added functionality, exhaust filters are seamlessly integrated into the cabinet's ceiling.

Heating components are present, accompanied by a thermostat fortified with a hygrostat. These units are mounted on the cabinet's lateral walls using a DIN rail installation.

Illuminating the telecommunications compartment is a LED lamp. Automation is embedded within this system: the light is activated or deactivated in response to the door opening sensor. For flexible operation, the lamp possesses a magnetic base, granting users the liberty to temporarily attach it to any metallic segment of the cabinet as required.

This embodiment of the invention showcases an advanced microclimate system power supply, incorporating flexibility, and functionality, ensuring optimal performance and adaptability of electricity generation system in various conditions.

The present invention as described in the claims and detailed description offers several distinct advantages:

Versatile Airflow Capture: Unlike traditional wind turbines that rely exclusively on natural wind, this system can harness the airflow from all direction generated by passing vehicles in addition to natural wind. This multiple-source approach allows for continues energy generation even during times when natural wind may be minimal.

Omnidirectional Wind Capture: The helicoid blade design is adept at capturing wind from any direction. This eliminates the need for mechanisms to rotate or reorient the turbine to face prevailing wind directions, reducing wear and maintenance requirements.

Efficient Energy Conversion: The helical contour of the blades ensures a prolonged interaction with the wind, converting more of the wind's kinetic energy into rotational mechanical energy, leading to higher energy capture efficiency.

Consistent Energy Output: With the inclusion of a sophisticated controller, the system can regulate and stabilize the generated electricity, ensuring a consistent and reliable energy supply, free from harmful surges or drops.

Energy Storage Capability: The integrated battery system means that energy can be stored during periods of high wind activity and used during lulls, ensuring a steady supply and increasing the system's overall utility.

Enhanced Safety and Noise Reduction: The vertical axis design, combined with the helicoid blade configuration, can potentially produce less noise and pose fewer risks to birds and other wildlife compared to traditional horizontal axis turbines.

Compact design: The vertical axis design, coupled with the unique helicoid blades, allows for a more compact footprint, making it suitable for urban environments. Furthermore, the helicoid design can be perceived as a modern, aesthetically pleasing structure, blending seamlessly with contemporary urban landscapes.

Scalability: The system can be easily scaled. Multiple units can be installed along busy roads or highways, making it possible to harness more energy from vehicular traffic, which is particularly beneficial in dense urban settings.

Eco-Friendly Energy Source: By harnessing an overlooked source of wind energy, the system provides an eco-friendly solution that reduces dependence on fossil fuels and helps decrease greenhouse gas emissions.

In conclusion, the helicoid vertical axis wind turbine system is a revolutionary advancement in renewable energy technology, merging innovative design with practical applications to harness wind energy more effectively and efficiently.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. A system for generating electricity using a helicoid vertical axis wind turbine comprising:
a rotor designed for rotation from airflow;
a plurality of helicoid blades having an airplane wing profile to generate a lifting force from said airflow, enabling rotation of the rotor;
a generator mechanically connected to the rotor to produce electricity upon the rotor's rotation;
a controller connected to said generator to process the generated electricity;
a battery connected to the controller for storing the processed electricity; and
an inverter connected to the battery for converting and supplying the stored electricity.

2. The system of claim 1, wherein the blade is fabricated from a composite material or plastic produced by vacuum pressing.

3. The system of claim 1, wherein the airflow is derived from natural wind or passing vehicles or a combination thereof.

4. A method for generating electricity using a helicoid vertical axis wind turbine, the method comprising:
capturing airflow from passing vehicles or natural wind or a combination thereof;
converting said airflow into a rotational force using the rotor configured a helicoid blade;
transferring the rotational force to the generator to produce electricity;
processing the generated electricity through the controller;
storing the processed electricity in the battery; and
supplying the stored electricity through the inverter.
